(19) United States
(12) Patent Application Publication
(10) Pub. No.: US 2013/0148781 A1
(43) Pub. Date: Jun. 13, 2013

(54) RADIATION GENERATING APPARATUS

(71) Applicant: Canon Kabushiki Kaisha, Tokyo (JP)

(72) Inventors: Koji Yamazaki, Ayase-shi (JP); Kazuyuki Ueda, Tokyo (JP)

(73) Assignee: CANON KABUSHIKI KAISHA, Tokyo (JP)

(21) Appl. No.: 13/667,307

(22) Filed: Nov. 2, 2012

(30) Foreign Application Priority Data
Dec. 9, 2011 (JP) 2011-270081

(51) Int. Cl. H01J 35/16; G01N 23/04

(52) U.S. Cl. 378/62; 378/142

(57) ABSTRACT

In a radiation generating apparatus of the present invention, a radiation tube in which a tubular side wall is arranged between a cathode and an anode is enclosed in an envelope filled with an insulating liquid. A thermally-conductive fin projecting to a side of a barrel portion of the radiation tube is provided on at least a part of an inner surface of the envelope, and the fin is provided on an area except for an area facing a position of the barrel portion at which potential of the barrel portion is higher than potential of the fin. Since a proper-shape cooling structure is provided on a proper position in the envelope, it is possible to secure withstand voltage and also made the entire apparatus compact in size.

### BACKGROUND OF THE INVENTION

1. Field of the Invention

The present invention relates to a radiation generating apparatus in which a radiation tube is enclosed in an envelope filled with an insulating liquid.

2. Description of the Related Art

A radiation tube, which is a vacuum tube consisting of a cathode, an anode and an insulating tubular side wall, accelerates an electron emitted from an electron source of the cathode by high voltage applied between the cathode and the anode, irradiates a metal target provided on the anode with the accelerated electron, and thus generates a radiation. In a radiation generating apparatus in which the radiation tube like this has been enclosed in an envelope filled with an insulating liquid, the target is heated by the irradiation of the electron, the heat generated from the target is conducted to the peripheral insulating liquid, and the temperature of the insulating liquid is thus increased. Consequently, there are fears that the insulating liquid is deteriorated due to the increase of the temperature, and withstand voltage is thus decreased. For this reason, it is necessary to suppress or control the increase of the temperature of the insulating liquid by rapidly radiating the heat conducted to the insulating liquid. For example, each of Japanese Patent Application Laid-Open Nos. 2002-175899 and 2004-022459 discloses a technique of cooling an insulating liquid by providing an exothermic fin on the outer side of an envelope of a radiation generating apparatus and an endothermic fin on the inner side of the envelope thereof.

In the conventional structure, the endothermic fin is arranged on the inner side of the envelope so as to substantially face the whole area expanding from the cathode to the anode of the radiation tube. Since the potential of the envelope of the radiation generating apparatus is usually set to be the ground potential, a so-called electric field concentration comes to occur easily depending on the potential to be applied to the radiation tube. In general, when the electric field concentration occurs, the potential of the endothermic fin becomes relatively low in regard to the radiation tube. In such a case, to secure the withstand voltage, it is necessary to have a reasonable distance in the radiation tube as compared with a case where there is no endothermic fin, whereby such a circumstance becomes a barrier to achieve downsizing.

Consequently, an object of the present invention is to provide a radiation generating apparatus which is equipped with a cooling structure having an insulating liquid in the envelope thereof, and can secure the withstand voltage and downsize the entire apparatus.

### SUMMARY OF THE INVENTION

In order to solve such conventional problems as described above, in the present invention, there is provides a radiation generating apparatus in which a radiation tube that a tubular side wall of a dielectric is arranged between a cathode having an electron-emitting device and an anode on which a target for generating a radiation in response to irradiation of an electron emitted from the electron-emitting device is provided is enclosed in an envelope which is filled with an insulating liquid, wherein a thermally-conductive fin projecting to a barrel portion of the radiation tube is provided on at least a part of an inner surface of the envelope, and the fin is provided on an area except for an area facing a position of the barrel portion at which potential of the barrel portion is higher than potential of the fin.

Moreover, in the present invention, there is provided a radiation generating apparatus in which a radiation tube that a tubular side wall of a dielectric is arranged between a cathode having an electron-emitting device and an anode on which a target for generating a radiation in response to irradiation of an electron emitted from the electron-emitting device is provided is enclosed in an envelope which is filled with an insulating liquid, wherein a thermally-conductive fin is provided on at least a part of an inner surface of the envelope so as to project to a barrel portion of the radiation tube, and, as a potential difference between the fin and the barrel portion becomes large, a distance between the fin and the barrel portion becomes large.

According to the present invention, the thermally-conductive fin absorbs the heat from the insulating liquid and conducts the absorbed heat to the envelope, thereby radiating the excessive heat to the outside through the envelope. Thus, it is possible to rapidly cool the insulating liquid. Moreover, the fin is provided so as to be able to suppress the decrease of the withstand voltage even if the distance between the fin and the barrel portion of the radiation tube is made small. Thus, it is possible to secure the withstand voltage, and it is also possible to downsize the entire apparatus.

Further features of the present invention will become apparent from the following description of the exemplary embodiments with reference to the attached drawings.

### BRIEF DESCRIPTION OF THE DRAWINGS

FIG. 1A is a cross section schematic diagram illustrating an example of a radiation generating apparatus according to the present invention, and FIG. 1B is a cross section schematic diagram corresponding to the line 1B-1B of FIG. 1A.

FIG. 2 is a cross section schematic diagram illustrating an example of a radiation tube to be used in the radiation generating apparatus according to the present invention.

FIG. 3A is a cross section schematic diagram illustrating the radiation generating apparatus in Example 2, and FIG. 3B is a cross section schematic diagram corresponding to the line 3B-3B of FIG. 3A.

FIG. 4 is a cross section schematic diagram illustrating the radiation generating apparatus in Example 3.

FIG. 5A is a cross section schematic diagram illustrating the radiation generating apparatus in Example 4, and FIG. 5B is a cross section schematic diagram corresponding to the line 5B-5B of FIG. 5A.

FIG. 6 is a block diagram illustrating a radiographic system according to the present invention.

### DESCRIPTION OF THE EMBODIMENTS

Hereinafter, exemplary embodiments of a radiation generating apparatus according to the present invention will be described in detail with reference to the attached drawings. Here, it should be noted that materials, dimensions, shapes, relative arrangements and the like of the constituent members described in the following exemplary embodiments do not limit the scope of the present invention, unless otherwise described. Also, it should be noted that X-rays are suitable as the radiation to be used in the present invention.

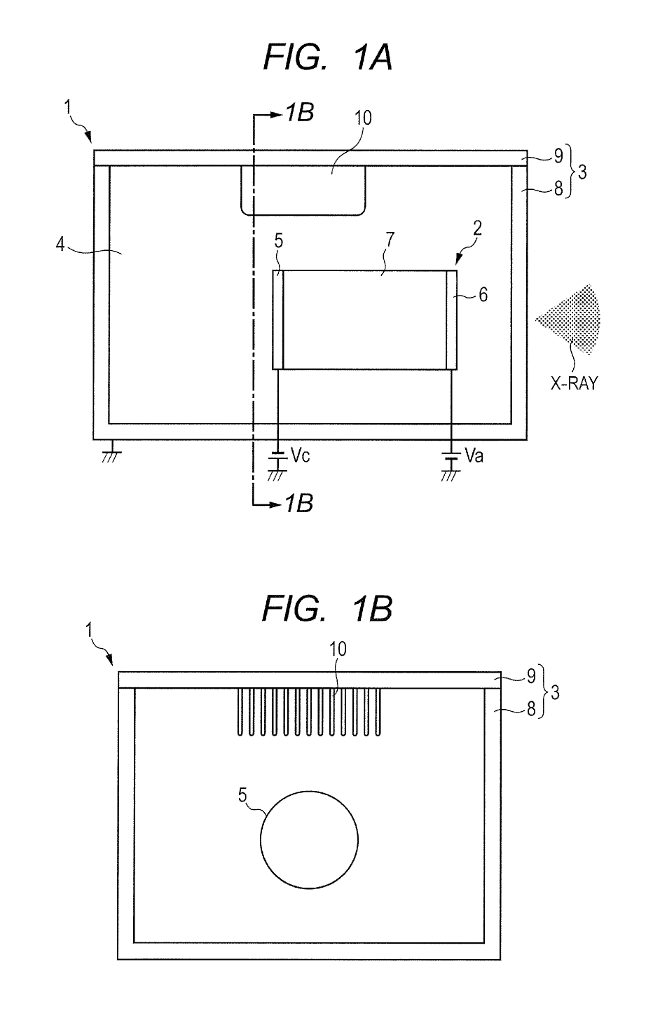

The constitution of the radiation generating apparatus according to the present invention will be described with reference to FIGS. 1A and 1B. Here, FIG. 1A is the cross section schematic diagram illustrating an example of the radiation generating apparatus according to the present invention, and FIG. 1B is the cross section schematic diagram corresponding to the line 1B-1B of the radiation generating apparatus in FIG. 1A. Incidentally, FIG. 1A indicates the cutaway by which the inside of the radiation generating apparatus can be easily understood.

A radiation generating apparatus 1 is formed by enclosing a radiation tube 2 in an envelope 3 together with an insulating liquid 4. Any of a reflection type radiation tube and a transmission type radiation tube can be used for the radiation tube 2, and a radiation transmission window (not illustrated) may be provided at the envelope 3 in accordance with a radiating position of the radiation tube 2.

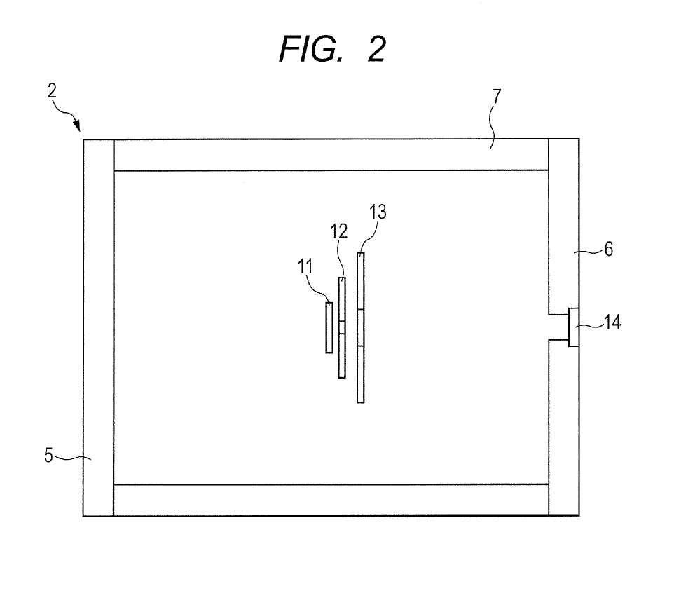

Hereinafter, the structure of a transmission type radiation tube to be used for the radiation generating apparatus according to the present invention will be briefly described. FIG. 2 is a cross section schematic diagram illustrating an example of the transmission type radiation tube.

The radiation tube 2 is a vacuum tube formed by sealing a cathode 5, an anode 6 and a tube 7 composed of a dielectric substance (hereinafter, referred to as “tubular side wall 7”), which is arranged between the cathode and the anode. An electron gun structure having an electron-emitting device is connected to the cathode 5. The electron gun structure, which is potentially defined on the basis of potential of the cathode 5, is arranged inside the radiation tube 2. This electron gun structure is mainly composed of an electron source 11, a grid electrode 12 and a focusing electrode 13. A target 14, which generates a radiation by the irradiation of electrons emitted from the electron-emitting device, is provided at the anode 6. The voltage, which is about from several tens kV to several hundred kV, is applied to this anode 6. Although there are not many restrictions about a shape of the tubular side wall 7, a cylindrical form is preferable if considering about the miniaturization or easiness in manufacturing. However, for example, a horn tube or the like other than the cylindrical form is also available. In FIG. 2, a shape of the tubular side wall 7 is formed as a cylindrical form, and a shape of the cathode 5 and the anode 6 is such a shape according to an aperture of the tubular side wall 7, that is, it is formed as a circular form. In this kind of transmission type radiation tube, an electron beam generated at the electron source 11 and extracted by the grid electrode 12 is directed toward the target 14 on the anode 6 by the focusing electrode 13 then accelerated by the voltage applied to the anode 6 to be collided with the target 14, thereby generating the radiation. At least a part of the radiation transmits through the target 14 to be extracted to the outside of the radiation tube 2.

The envelope 3, which is composed of a container unit 8 and a cover unit 9, is formed by fixing the radiation tube 2 to the container unit 8 and sealing the container unit with the cover unit 9. As the materials of the envelope 3, metals such as iron, stainless, lead, brass, copper and the like can be used. The insulating liquid 4 can be injected into the envelope 3 from a filler hole (not illustrated) provided at a part of the envelope 3. It is preferable that a potential of the envelope 3 is defined to become the ground potential.

It is preferable that the insulating liquid 4 has high electric insulation and a high cooling capacity. In addition, the insulating liquid, of which the quality is little changed by the heat, is preferable. For example, an electric insulating oil, a fluorinated insulating oil or the like can be used.

When the above radiation generating apparatus is operated, the radiation tube 2 (particularly, the anode 6) generates the heat, and that heat increases a temperature of the insulating liquid 4. Furthermore, there occurs such a convection flow of the insulating liquid 4 which moves toward a portion, where a potential is lower than an anode potential, mainly from the anode 6. Since the insulating liquid 4 thermally expands by the rise of temperature, there is some fear of damaging the envelope 3 (for example, leakage of liquid from a sealing portion between the container unit 8 and the cover unit 9). In addition, the insulating liquid 4 is deteriorated by the rise of temperature, and there is some fear of decreasing the withstand voltage. Therefore, a fin 10, which has thermal conductivity and projected to a barrel portion side of the radiation tube 2, is provided at least at a part of an inner surface of the envelope 3. It is preferable that a potential of the fin 10 is defined to become the ground potential. The fin 10 absorbs heat from the insulating liquid 4 and emits the heat to the outside of the envelope 3 by thermally conducting the heat to the envelope 3. It is preferable that a shape of the fin 10 is a slit-like form as illustrated in FIG. 1B in order that the convection flow of the insulating liquid 4 is not blocked to occur and a contact area with the insulating liquid 4 is secured to maintain a large area. In FIG. 1B, although the fin 10 is provided at only the cover unit 9 of the envelope 3, the fin 10 may be provided at also the container unit 8 in order to increase the cooling capacity. In the outside of the envelope 3, it is preferable to increase the cooling efficiency of the insulating liquid 4 by positively radiating the heat by a cooling means such as a cooling fan or the like.

By the way, when the fin 10 is provided at an inner surface of the envelope 3, there is some fear of decreasing the withstand voltage between the fin 10 and a barrel portion of the radiation tube 2 by the potential difference between the radiation tube 2 and the fin depending on a position. The decreasing of the withstand voltage causes the size increasing of the envelope 3, and this fact becomes an obstacle of the miniaturization. Since the electric field concentration tends to occur easily at a tip of the fin 10 as compared with a plane, electrons tend to be more easily emitted from a tip of the fin 10 to the side of the radiation tube 2 in a region of (the potential of the fin 10<the potential of the radiation tube 2) than a region of (the potential of the fin 10>the potential of the radiation tube 2), and the emitted electrons are accelerated. For this reason, in the region of (the potential of the fin 10<the potential of the radiation tube 2), an electric discharge due to such a phenomenon, where electrons are emitted from a tip of the fin 10 then the electrons collide with the radiation tube 2, tends to easily occur. That is, in the region of (the potential of the fin 10<the potential of the radiation tube 2), the withstand voltage tends to be easily decreased. For example, in a case that fins 10, of which thickness is about 1 mm and cross sections of the tip have a semicircular form, are arranged with an interval of about 5 mm, the field intensity is increased to about the double intensity as compared with a case of a plane plate. Therefore, in the present invention, it is not required to increase the size of the envelope 3 by forming that the projecting length of the fins 10 from an inner surface of the envelope 3 is made to be uneven in accordance with the potential of a barrel portion of the radiation tube 2 which faces to the fins 10. Specifically, it is preferable to provide the fins 10 as follows.

When the fin 10 is provided at a position excepting a region which faces to a position of a barrel portion of the radiation tube 2 of which the potential becomes higher than the potential of the fin 10, since the region of (the potential of the fin 10<the potential of the radiation tube 2) is not appeared, the electric discharge hardly occurs. In this case, it is preferable to provide the fin 10 so as to increase a distance between the fin 10 and a barrel portion of the radiation tube 2 to become a long distance according as the potential difference between the fin 10 and a barrel portion of the radiation tube 2 becomes a large difference. By constituting like this, the filed intensity between the fin 10 and a barrel portion of the radiation tube 2 does not become large in the region of (the potential of the fin 10>the potential of the radiation tube 2) to be preferably resulted.

When the fin 10 is provided so as to increase a distance between the fin 10 and a barrel portion of the radiation tube 2 to become a long distance according as the potential difference between the fin 10 and a barrel portion of the radiation tube 2 becomes a large distance, the filed intensity between the fin 10 and a barrel portion of the radiation tube 2 does not become large to be preferably resulted. Further, in this case, it is preferable to provide the fin 10 so that the change of distance between the fin 10 and a barrel portion of the radiation tube 2 becomes more gradual at a side where the potential of a barrel portion of the radiation tube 2 becomes lower than the potential of the fin 10 than a side where the potential of a barrel portion of the radiation tube 2 becomes higher than the potential of the fin 10.

It is preferable to constitute that the shortest distance from a barrel portion of the radiation tube 2 to the fin 10 becomes equal to or longer than the shortest distance from the radiation tube 2 to the envelope 3. By constituting like this, the field intensity between the radiation tube 2 and the envelope 3 does not become large to be preferably resulted.

When the same potential is set to the fin 10 and the anode 6, since the potential of a barrel portion of the radiation tube 2 is lower than the potential of the fin 10, a restriction for the arrangement of the fin 10 is decreased, and it is allowed that the fin 10 is arranged only on the periphery of the anode 6 which acts as a heat source.

Since there is possibility that the insulating liquid 4 stays at corner portions or the like inside the envelope 3, a rectifying structure 16, which makes a flow of the insulating liquid 4 direct toward the fin 10, is allowed to be provided on the periphery of the anode 6.

### Example 1

The constitution of a radiation generating apparatus in this example is the same as that exemplified in the above embodiment (FIGS. 1A and 1B).

The radiation generating apparatus 1 is formed by enclosing the radiation tube 2 in an envelope and filling the insulating liquid 4 into the envelope. The radiation tube 2 is a transmission type radiation tube which is formed by holding the tubular side wall 7 between the cathode 5 and the anode 6 and sealing these members (FIG. 2). The electron gun structure (the electron source 11, the grid electrode 12, and the focusing electrode 13) based on the anode potential is connected with the cathode 5, and the target 14 is provided at the anode 6. The kovar is used for the cathode 5 and the anode 6, and the alumina is used for the tubular side wall 7, and they were bonded with each other by a brazing method. The shape of the cathode 5 and the anode 6 was formed as a circular form and the shape of the tubular side wall 7 was formed as a cylindrical form. An impregnated cathode is used for the electron source 11. A substance obtained by depositing tungsten on a diamond substrate is used for the target 14. The anode 6 was defined to become positive potential and the cathode 5 was defined to become negative potential.

The envelope 3 made of brass, of which a shape is a rectangular solid form, is composed of the cover unit 9 for one surface and the container unit 8 for a part other than the one surface, and the envelope was defined to become the ground potential. A packing material used for the sealing (not illustrated) is provided at a joint between the container unit 8 and the cover unit 9, which were sealed by fixing with screws. The radiation tube 2 was arranged so that the tubular side wall 7 becomes parallel with the cover unit 9. In addition, the fin 10, which projects to the barrel portion side of the radiation tube 2, was provided at a position excepting a region which faces to a position of a barrel portion of the radiation tube 2, of which the potential becomes higher than the potential of the fin 10, on an inner surface of the cover unit 9. The potential of the fin 10 is also equal to the ground potential. A tip of the fin 10 made of brass, of which thickness is 1 mm, is chamfered to have such a radius equal to 0.5 mm, and thirteen pieces of the fins are arranged with an interval of 4 mm. The shortest distance from a barrel portion of the radiation tube 2 to the fin 10 is made to become equal to or longer than the shortest distance from the radiation tube 2 to the envelope 3, and the field intensity between the radiation tube 2 and the envelope 3 is made not to become large. Although the field intensity of the tip of the fin 10 locally becomes high, since the potential of the fin 10 is higher than the potential of the radiation tube 2 at a position which faces to the fin 10, the electric discharge hardly occurs.

A high voltage insulating oil A (produced by JX Nippon Oil & Energy Corporation) is used for the insulating liquid 4, which is filled into the envelope from a filler hole (not illustrated) provided at the envelope 3.

As mentioned above, the field intensity is increased at a tip of the fin 10. In this example, the field intensity is increased to about the double intensity at the tip of the fin 10. According to this fact, if the fin 10 is provided at the whole region which faces to a barrel portion of the radiation tube 2 and the withstand voltage is intended to secure, the distance between the fin 10 and a barrel portion of the radiation tube 2 has to be increased to such a distance nearly equal to at least the shortest distance between the radiation tube 2 and the envelope 3. On the other hand, in the present embodiment, since the fin 10 is provided at a position excepting a region which faces to a position of a barrel portion of the radiation tube 2, of which the potential becomes higher than the potential of the fin 10, the shortest distance between the radiation tube 2 and the envelope 3 can be reduced to a short distance as compared with a case that the fin 10 is provided at the whole region which faces to a barrel portion of the radiation tube 2. Accordingly, the miniaturization of an apparatus can be realized by this example.

When the radiation generating apparatus 1 in this example was driven with the potential of −50 kV for the cathode 5 and the potential of 50 kV for the anode 6, a radiation could be generated without an obstacle due to the electric discharge. In addition, the damage of the envelope 3 such as an oil leakage or the like due to the increasing of temperature did not occur. Further, even if the apparatus has been driven for a long time, the electric discharge did not occur and the deterioration of the withstand voltage was not confirmed.

### Example 2

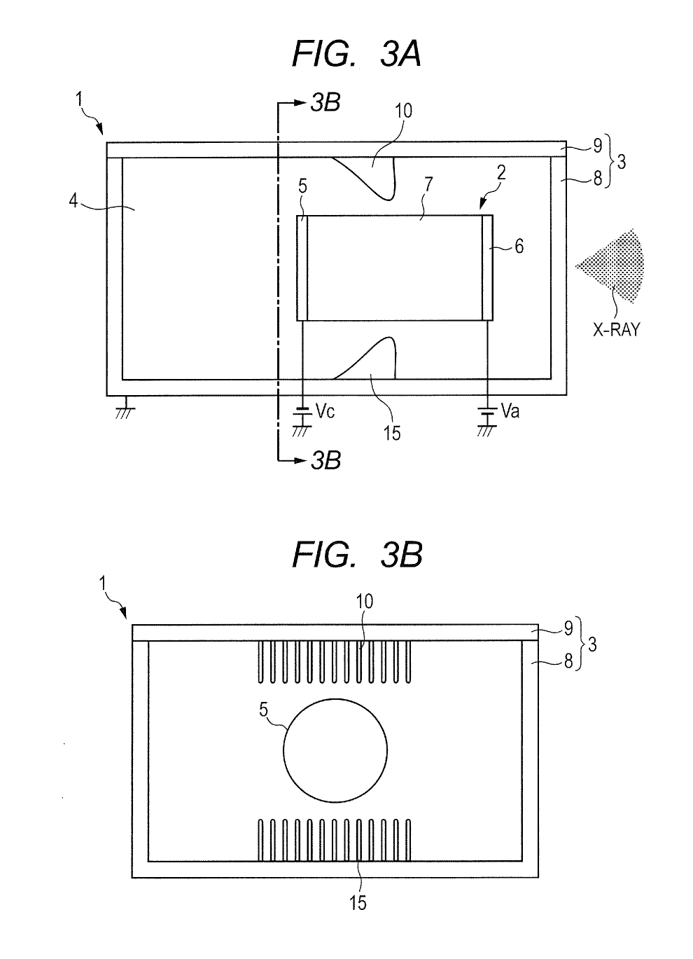

The constitution of a radiation generating apparatus 1 in this example is different from the constitution of the Example 1. The projecting length of the fin from the cover unit 9 is decreased according as the fin 10 approaches closer to the cathode 5 as illustrated in FIGS. 3A and 3B. That is, the fin 10 was provided so as to increase a distance between the fin 10 and a barrel portion of the radiation tube 2 to become a long distance according as the potential difference between the fin 10 and a barrel portion of the radiation tube 2 becomes a large difference. In addition, a fin 15 which becomes a symmetric relation with the fin 10 for the radiation tube 2 was provided on a surface opposite to the cover unit 9 of the envelope 3. Excepting the above different points, the constitution of this example is the same as that of the Example 1.

In the Example 1, since the potential difference between the fin 10 and a barrel portion of the radiation tube 2 becomes a large difference according as the fin approaches closer to the cathode 5, the fin 10 and a barrel portion of the radiation tube 2 have to be separated each other by the required distance in the vicinity of the cathode 5. On the other hand, since the potential difference between the fin 10 and a barrel portion of the radiation tube 2 does not almost occur in the vicinity of an intermediate point between the cathode 5 and the anode 6, the distance between the fin 10 and a barrel portion of the radiation tube 2 can be shortened in the vicinity of the intermediate point. Therefore, the distance between the radiation tube 2 and the envelope 3 can be suppressed to the minimum distance by forming the fin 10 into a shape as in this example, and the apparatus can be further miniaturized than the miniaturization in the Example 1.

Since the endothermic effect is faded out by decreasing an area of the fin 10, an endothermic area is supplemented by providing the fin 15 on a surface opposite to the cover unit 9 in this example. Of course, the distance between the radiation tube 2 and the envelope 3 is not required to increase due to the fin 15.

When the radiation generating apparatus 1 in this example was driven with the potential of −50 kV for the cathode 5 and the potential of 50 kV for the anode 6, a radiation could be generated without an obstacle due to the electric discharge. In addition, the damage of the envelope 3 such as an oil leakage or the like due to the increasing of temperature did not occur. Further, even if the apparatus has been driven for a long time, the electric discharge did not occur and the deterioration of the withstand voltage was not confirmed.

### Example 3

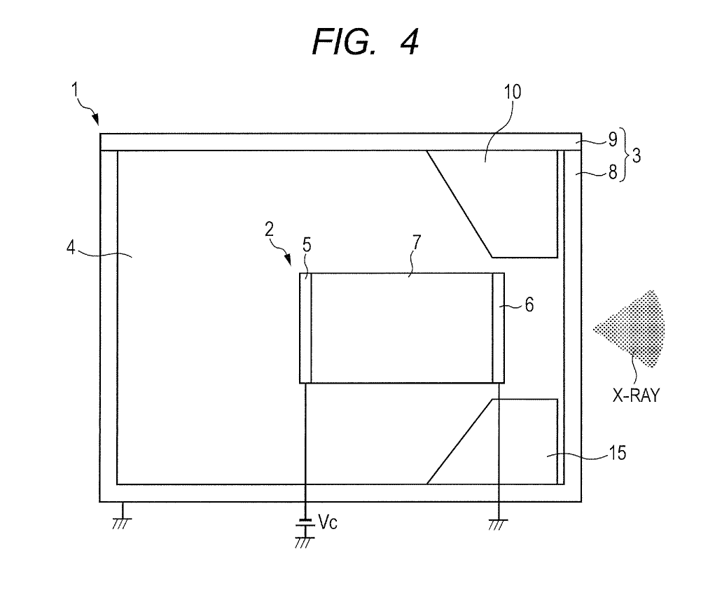

The constitution of a radiation generating apparatus in this example is different from the constitution of the Example 2. As illustrated in FIG. 4, the anode 6 was defined as the ground potential, and the fins 10 and 15 were arranged only on the periphery of the anode 6. Excepting this different point, the constitution is the same as that of the Example 2. The potential definition as in this example is generally called as a grounded-anode. In case of the grounded-anode, the intensity of the potential difference between the cathode 5 and the envelope 3 becomes double the intensity, and a distance between the radiation tube 2 and the envelope 3 is also required to become double the distance. Therefore, when the fins 10 and 15 are provided, the envelope 3, of which the size is more increased, is required. However, when the fins 10 and 15 are arranged only on the periphery of the anode (preferably, a portion between the anode 6 and the envelope 3) as in this example, the size increasing of the envelope 3 due to the fins 10 and 15 is only resulted in a little change. In addition, since these fins can be arranged in the vicinity of the target 14 which acts as a heat generating unit, the endothermic effect becomes high.

When the radiation generating apparatus 1 in this example was driven with the potential of −100 kV for the cathode 5, a radiation could be generated without an obstacle due to the electric discharge, and the increasing of temperature could be more suppressed as compared with a case of the Example 2.

### Example 4

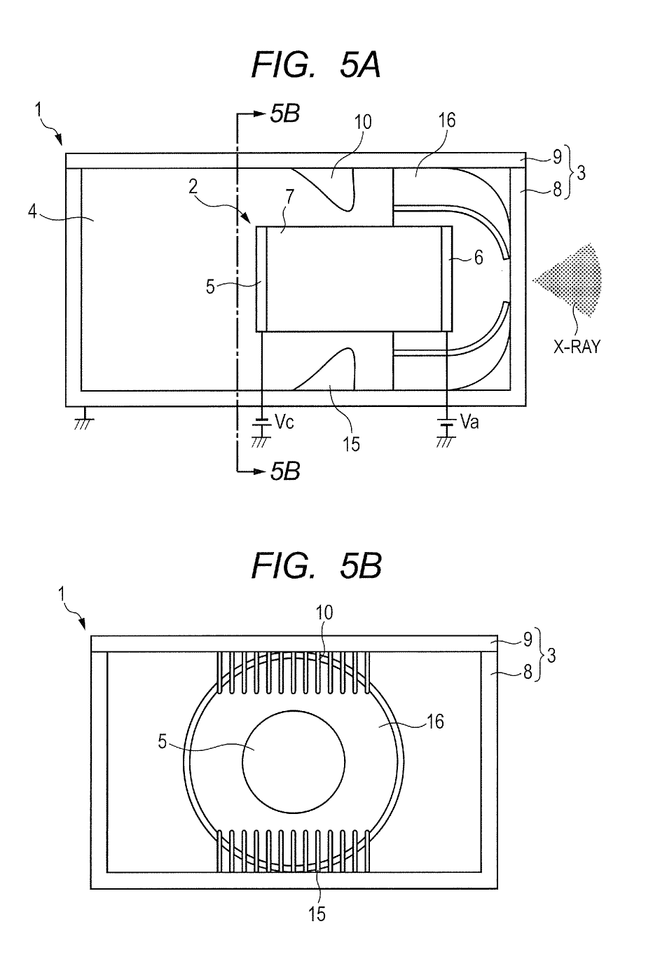

In addition to a case of the Example 2, in a radiation generating apparatus in this example, a rectifying structure 16 for rectifying the insulating liquid 4 to direct toward the fin 10 was provided between the anode 6 and the envelope as illustrated in FIGS. 5A and 5B. Since the insulating liquid 4 flows like a turbulent flow, the insulating liquid is not always flowing to the direction of the fin 10. Therefore, in this example, the rectifying structure 16, which makes the insulating liquid 4 efficiently direct toward the fins 10 and 15, is provided. The rectifying structure 16 was formed by the brass to be shaped like a hood. The rectifying structure 16 is arranged in such a way as to contact with an inner surface of the cover unit 9, a surface faced to the cover unit 9 of the envelope 3 and a surface faced to the anode 6 of the envelope 3, and it was designed to conduct the heat to the envelope 3 also from the rectifying structure 16.

When the radiation generating apparatus 1 in this example was driven with the potential of −50 kV for the cathode 5 and the potential of 50 kV for the anode 6, a radiation could be generated without an obstacle due to the electric discharge, and the increasing of temperature could be more suppressed as compared with a case of the Example 2.

### Example 5

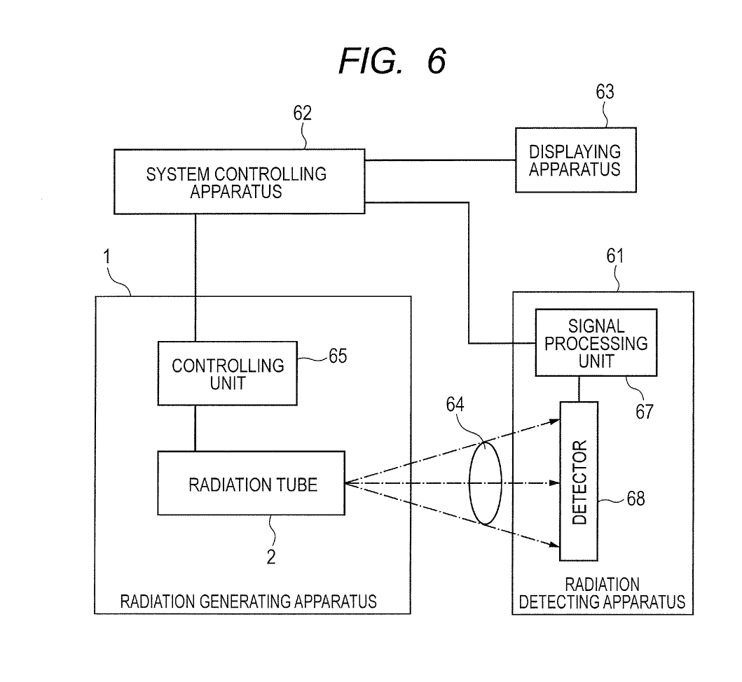

FIG. 6 is a block diagram of a radiographic system according to the present invention. A system controlling apparatus 62 cooperatively controls a radiation generating apparatus 1 and a radiation detecting apparatus 61. A controlling unit 65 outputs various control signals to the radiation tube 2 under the control performed by the system controlling apparatus 62. The emitting condition of a radiation to be emitted from the radiation generating apparatus 1 is controlled by the control signals. The radiation emitted from the radiation generating apparatus 1 transmits through a subject 64 to be detected at a detector 68. The detector 68 converts the detected radiation into an image signal and then outputs the image signal to a signal processing unit 67. The signal processing unit 67 performs a predetermined signal processing to the image signal under the control performed by the system controlling apparatus 62 and then outputs the processed image signal to the system controlling apparatus 62. The system controlling apparatus 62 outputs a display signal used for displaying an image on a displaying apparatus 63 to the displaying apparatus 63 on the basis of the processed image signal. The displaying apparatus 63 displays an image, which is based on the display signal, on a screen as a photographed image of the subject 64.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-270081, filed Dec. 9, 2011, which is hereby incorporated by reference herein in its entirety.

What is claimed is:

1. A radiation generating apparatus in which a radiation tube that a tubular side wall of a dielectric is arranged between a cathode having an electron-emitting device and an anode on which a target for generating a radiation in response to irradiation of an electron emitted from the electron-emitting device is provided is enclosed in an envelope which is filled with an insulating liquid, wherein
a thermally-conductive fin projecting to a barrel portion of the radiation tube is provided on at least a part of an inner surface of the envelope, and
the fin is provided on an area except for an area facing a position of the barrel portion at which potential of the barrel portion is higher than potential of the fin.

2. The radiation generating apparatus according to claim 1, wherein, as a potential difference between the fin and the barrel portion becomes large, a distance between the fin and the barrel portion becomes large.

3. The radiation generating apparatus according to claim 1, wherein
the fin and the anode are set to have the same potential, and
the fin is provided on the periphery of the anode.

4. The radiation generating apparatus according to claim 1, wherein a rectifying structure for rectifying the insulating liquid so as to move on to the fin is provided between the anode and the envelope.

5. The radiation generating apparatus according to claim 1, wherein the potential of the fin is ground potential.

6. The radiation generating apparatus according to claim 1, wherein potential of the anode is positive potential and potential of the cathode is negative potential.

7. A radiation generating apparatus in which a radiation tube that a tubular side wall of a dielectric is arranged between a cathode having an electron-emitting device and an anode on which a target for generating a radiation in response to irradiation of an electron emitted from the electron-emitting device is provided is enclosed in an envelope which is filled with an insulating liquid, wherein
a thermally-conductive fin is provided on at least a part of an inner surface of the envelope so as to project to a barrel portion of the radiation tube, and
as a potential difference between the fin and the barrel portion becomes large, a distance between the fin and the barrel portion becomes large.

8. The radiation generating apparatus according to claim 7, wherein a change of the distance between the fin and the barrel portion on a side that potential of the barrel portion is smaller than potential of the fin is gradual as compared with a change of the distance between the fin and the barrel portion on a side that the potential of the barrel portion is larger than the potential of the fin.

9. The radiation generating apparatus according to claim 7, wherein the potential of the fin and potential of the anode are positive potential, and potential of the cathode is negative potential.

10. A radiographic system comprising:
a radiation generating apparatus in which a radiation tube that a tubular side wall of a dielectric is arranged between a cathode having an electron-emitting device and an anode on which a target for generating a radiation in response to irradiation of an electron emitted from the electron-emitting device is provided is enclosed in an envelope which is filled with an insulating liquid, wherein
a thermally-conductive fin projecting to a barrel portion of the radiation tube is provided on at least a part of an inner surface of the envelope, and
the fin is provided on an area except for an area facing a position of the barrel portion at which potential of the barrel portion is higher than potential of the fin;
a radiation detecting apparatus which detects the radiation which was emitted by the radiation generating apparatus and which transmitted a subject; and
a controlling apparatus which coordinately controls the radiation generating apparatus and the radiation detecting apparatus.
